(19) United States
(12) Patent Application Publication
(10) Pub. No.: US 2010/0207741 A1
(43) Pub. Date: Aug. 19, 2010

(54) METHOD, APPARATUS AND SYSTEM FOR USE IN CONNECTION WITH THE INSPECTION OF LIQUID MERCHANDISE

(75) Inventors: Dan Gudmundson, Quebec (CA); Luc Perron, Charlesbourg (CA); Eric Bolduc, Quebec (CA)

Correspondence Address: LADAS & PARRY LLP, 224 SOUTH MICHIGAN AVENUE, SUITE 1600, CHICAGO, IL, 60604, US

(73) Assignee: OPTOSECURITY INC., Quebec, Quebec (CA)

(21) Appl. No.: 12/681,826

(22) PCT Filed: Oct. 10, 2008
(86) PCT No.: PCT/CA08/01792

§ 371 Date: Apr. 6, 2010

Related U.S. Application Data
(60) Provisional application No. 60/978,962, filed on Oct. 10, 2007.

(51) Int. Cl. G06K 7/01; G06K 9/00; G06F 17/00

(52) U.S. Cl. 340/10.42; 382/100; 235/375

(57) ABSTRACT

A method for facilitating the inspection of liquid merchandise is provided. A machine readable tag is generated and is associated with liquid merchandise purchased at a duty free point of sale or other secure sales or distribution location, the machine readable tag conveying identification information related to the liquid merchandise. At a security check-point, the identification information is extracted from the machine readable tag and is used in conjunction with an X-ray image of the liquid merchandise to determine if the liquid merchandise is consistent with the identification information. A system and an apparatus for implementing the method presented are also provided.

### CROSS-REFERENCE TO RELATED APPLICATION

This application claims the benefit under 35 USC §120 of U.S. provisional patent application Ser. No. 60/978,962 filed Oct. 10, 2007 and presently pending. The contents of the above-mentioned patent application are incorporated herein by reference.

### FIELD OF THE INVENTION

The present invention relates generally to security systems and, more particularly, to methods and systems for assessing properties of liquids, in particular determining if a container of liquid presents a potential security threat. The invention has numerous applications; in particular it can be used for scanning containers of liquid purchased at duty free shops at airport security check points.

### BACKGROUND

Security in airports, train stations, ports, office buildings and other public or private venues is becoming increasingly important particularly in light of recent violent events.

Some liquids or combinations of liquids and other compounds may cause enough damage to bring down an aircraft. As no reliable technology-based solution currently exists to adequately address this threat, authorities have implemented regulations banning most liquids, gels and aerosols in cabin baggage. As a result, there have been disruptions in operations (e.g., a longer screening process; changed the focus for screeners; additional line-ups), major inconveniences for passengers (as well as potential health hazards for some) and economic concerns (e.g., increased screening costs; lost revenues for airports, airlines and duty free shops; large quantities of confiscated—including hazardous—merchandise to dispose of), and so on.

In particular, the current regulations established in most international airports prevent carrying any liquid container larger than 100 ml. The rationale behind such regulations is the belief that amounts of liquids below this threshold amount are unlikely to cause significant damage to an aircraft.

However, these regulations are causing significant financial damage to duty free businesses that operate in airports. Indeed, an effect of the current regulations is that no perfume or alcoholic beverages can be brought by passengers as “carry-on” items when they have to make a connection between the airport where they would make a duty free purchase and their final destination, since passengers have to get rid of liquids before going through security screening at the connecting airport. Since connecting flights are not uncommon, the observed result has been a significant decrease in duty free purchases as passengers are foregoing making purchases they would have otherwise made at duty free shops in the absence of the regulations. The decrease in duty free purchases is negatively affecting the revenues of not only duty free shops, but airport operators as well since many airport facilities rely on fees levied from duty free purchases.

In light of the above, there is a need in the industry for providing a method and system for assessing containers of liquid purchased at the duty-free shops so as to re-enable the carrying of duty free liquid merchandise onboard aircraft.

### SUMMARY

In accordance with a broad aspect, the invention provides a method for facilitating the inspection of duty free liquid merchandise. The method comprises generating a machine readable tag conveying identification information related to the duty free liquid merchandise and associating the machine readable tag with the duty free liquid merchandise. At a security checkpoint, the identification information is extracted from the machine readable tag and used in conjunction with an X-ray image of the duty free liquid merchandise in determining if the duty free liquid merchandise is consistent with the identification information.

In accordance with a specific example of implementation, the duty free liquid merchandise is purchased at a duty free point of sale and the machine readable tag conveying the liquid merchandise purchased at the duty free point of sale is generated. The machine readable tag may be generated at the duty free point of sale or at another location between the duty free point of sale and the security checkpoint. The machine readable tag is associated with the duty free liquid merchandise using any suitable fastening mechanism and may be fastened directly to the duty free liquid merchandise or on a receptacle, such as a bag, holding the duty free liquid merchandise. Alternatively, the machine readable tag may be associated with the traveler having purchased the duty free liquid merchandise.

In specific examples of implementation, the duty free liquid merchandise may include one or more containers of liquid.

In accordance with a specific example of implementation, the identification information conveyed by the machine readable tag is used to obtain an expected response to penetrating radiation associated with the duty free liquid merchandise, the expected response being related to an expected content of the duty free liquid merchandise. The X-ray image of the duty free liquid merchandise is then processed to derive an observed response to penetrating radiation associated with the duty free liquid merchandise. The observed response to penetrating radiation and the expected response to penetrating radiation are compared and the results are then used to determine if the duty free liquid merchandise being screened is consistent with the identification information conveyed by the machine readable tag.

In accordance with a specific example of implementation, a knowledge bank is provided including entries mapping different types of containers of liquid to one or more features. The features may convey expected responses of containers of liquid to penetrating radiation and geometric information associated with containers of liquid amongst other types of features. The identification information conveyed by the machine readable tag is used to locate one or more entries in the knowledge bank associated with the duty free liquid merchandise.

In a specific example of implementation, the duty free liquid merchandise is placed in a receptacle which is then sealed so that no items other than the duty free liquid merchandise may be placed within the receptacle prior to subjecting the duty free liquid merchandise to penetrating radiation. The receptacle may be any suitable container for holding the duty free liquid merchandise. In a first specific example of implementation, the receptacle is a bag including a sealing mechanism for sealing the bag subsequent to the duty free liquid merchandise being placed in the bag so that no additional items may be placed within the bag prior to subjecting the duty free liquid merchandise to penetrating radiation. In a second specific example of implementation, the receptacle is a box having a locking mechanism for locking and unlocking the box, the locking mechanism allowing the box to be sealed subsequent to the duty free liquid merchandise being placed in the box so that no additional items may be placed within the box prior to subjecting the duty free liquid merchandise to penetrating radiation.

Optionally, screening information is stored on the machine readable tag during security screening. The screening information may convey, for example:
an observed response to penetrating radiation associated with the duty free liquid merchandise;
an expected response to penetrating radiation obtained using the identification information conveyed by the machine readable tag;
information related to the results obtained when determining if the duty free liquid merchandise is consistent with the identification information; and
an x-ray image of the duty free liquid merchandise obtained when subjecting the duty free liquid merchandise to penetrating radiation.

In accordance with another broad aspect, the invention provides an apparatus for inspecting duty free liquid merchandise at a security checkpoint, the duty free liquid merchandise being associated with a machine readable tag. The apparatus comprises a first input for receiving identification information related to the duty free liquid merchandise from the machine readable tag, the machine readable tag being generated in connection with a purchase of the duty free liquid merchandise at a duty free point of sale. The apparatus also comprises a second input for receiving an X-ray image of the duty free liquid merchandise derived by subjecting the duty free liquid merchandise to penetrating radiation. The apparatus also comprises a processing unit in communication with the first input and the second input, the processing unit being programmed for using the identification information in conjunction with the X-ray image of the duty free liquid merchandise to determine if the duty free liquid merchandise is consistent with the identification information. The apparatus also comprises an output in communication with the processing unit for releasing information conveying results obtained by the processing unit when determining if the duty free liquid merchandise is consistent with the identification information.

In accordance with yet another broad aspect, the invention provides a system for inspecting duty free liquid merchandise. The system comprises a tag generator module for generating a machine readable tag conveying identification information associated with duty free liquid merchandise purchased at a duty free point of sale. The system also comprises a tag reader module for reading the machine readable tag associated with the duty free liquid merchandise and an x-ray screening device for subjecting the duty free liquid merchandise to penetrating radiation to generate an X-ray image of the duty free liquid merchandise. The system also comprises an apparatus having a first input in communication with the tag reader module for receiving the identification information conveyed by the machine readable tag and a second input in communication with the x-ray screening device for receiving the X-ray image of the duty free liquid merchandise. The apparatus also has a processing unit in communication with the first input and the second input, the processing unit being programmed for using the identification information in conjunction with the X-ray image of the duty free liquid merchandise to determine if the duty free liquid merchandise is consistent with the identification information. The system also comprises a display device in communication with said apparatus for displaying information related to the results obtained by the processing unit when determining if the duty free liquid merchandise is consistent with the identification information.

In a specific example of implementation, the system further comprises a memory module storing a knowledge bank including entries mapping different types of containers of liquid to one or more features, at least some features conveying expected responses of containers of liquid to penetrating radiation. The processing unit of the apparatus is programmed for using the identification information conveyed by the machine readable tag to locate one or more entries in the knowledge bank associated with the duty free liquid merchandise. Optionally, at least some features convey geometric information associated with containers of liquid.

In specific examples of implementation, the tag generator module may be embodied in any suitable device for generating a machine readable tag conveying identification information associated with the duty free liquid merchandise.

In a first non-limiting example, the computer readable tag includes a printed bar code component and the tag generator module comprises a bar code printing module and associated program for printing a bar code on a substrate (such as a label), the bar code conveying identification information associated with the duty free liquid merchandise.

In a second non-limiting example of implementation, the computer readable tag includes a metallic bar code component and the tag generator module comprises a bar code generation device for generating a bar code made out of a metallic substance, such as copper for example, the metallic bar code conveying identification information associated with the duty free liquid merchandise.

In a third non-limiting example of implementation, the computer readable tag includes an RFID component and the tag generator module comprises an RFID writer for storing identification information associated with the duty free liquid merchandise on the RFID component.

In accordance with a specific example of implementation, the system comprises an output module for storing information on the computer readable tag related to the results obtained by the processing unit of the apparatus when determining if the duty free liquid merchandise is consistent with the identification information.

In accordance with yet another broad aspect, the invention provides a system for inspecting liquid merchandise. The system comprises tag reader means for reading a machine readable tag associated with the liquid merchandise, the machine readable tag conveying identification information related to the liquid merchandise. The system also comprises x-ray screening means for subjecting the liquid merchandise to penetrating radiation to generate an X-ray image of the liquid merchandise. The system also comprises means for using the identification information in conjunction with the X-ray image of the liquid merchandise to determine if the liquid merchandise is consistent with the identification information. The system also comprises means for displaying information related to the results obtained by the processing unit when determining if the liquid merchandise is consistent with the identification information.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

A detailed description of embodiments of the present invention is provided herein below, by way of example only, with reference to the accompanying drawings, in which:

FIGS. 1, 2 and 3 are flow diagrams of a process for facilitating the inspection of duty free liquid merchandise in accordance with a specific example of implementation of the invention;

FIG. 4 is a block diagram of a system for use in inspecting duty free liquid merchandise in accordance with a specific example of implementation of the invention;

FIG. 5 is a block diagram of a processing apparatus for use in the system depicted in FIG. 4 in accordance with a specific example of implementation of the invention;

FIG. 6 is a table-like representation of a knowledge bank storing information related to duty free liquid merchandise in accordance with a specific example of implementation of the invention;

FIGS. 7a, 7b, 7c and 7d illustrate respective embodiments of machine readable tags in accordance with specific non-limiting examples of implementation of the invention;

FIG. 8 shows a functional block diagram of a system for use in inspecting duty free liquid merchandise in accordance with another specific example of implementation of the invention;

FIG. 9 shows a graphical user interface for display on a display device of the systems depicted in either one of FIG. 4 or 8 in accordance with a specific example of implementation of the invention;

FIG. 10 is a block diagram of an apparatus suitable for implementing portions of the process depicted in FIGS. 1, 2 and 3 in accordance with a specific example of implementation of the present invention;

FIG. 11 shows a functional block diagram of a client-server system suitable for implementing portions of the process depicted in FIGS. 1, 2 and 3 in accordance with an alternative specific example of implementation of the present invention;

FIG. 12 shows a flow diagram for updating a knowledge bank for use in connection with the system depicted in FIG. 4 in accordance with a specific example of implementation of the present invention;

FIG. 13 shows a functional block diagram of a system for use in inspecting liquid merchandise at the time of delivery to a secure location in accordance with yet another variant of the invention.

In the drawings, the embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION

Note that for the purpose of this description “liquid” refers to a state of matter that is neither gas nor solid and that generally takes the shape of the container in which it is held. This definition would therefore encompass substances that are pastes or gels, in addition to substances having a characteristic readiness to flow. For instance, toothpaste, and other materials having the consistency of toothpaste, would be considered to fall in the definition of “liquid”.

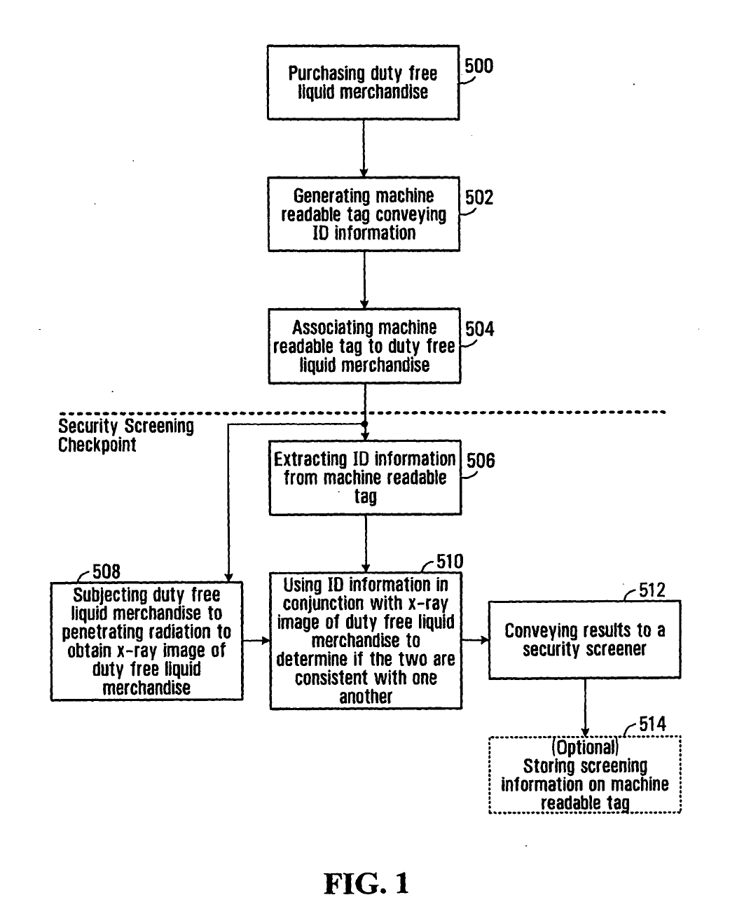

With reference to FIG. 1, there is shown a process for facilitating the inspection of duty free liquid merchandise in accordance with a specific example of implementation of the invention.

At step 500, duty free liquid merchandise is purchased by a passenger at a duty free point of sale, such as a duty free store within an airport. The duty free liquid merchandise may include a single container of liquid or may include a plurality of containers of liquid.

In a non-limiting example, the container(s) of duty free liquid merchandise may include those used for beer, wine, spirits, liquor, fruit juice/extract, soft drinks and other beverages of both alcoholic and non-alcoholic nature that are commonly sold at a duty free point of sale. Containers of duty free liquid merchandise may also include non-beverage liquids (e.g. containers of perfume or cologne), as well as gels and pastes and such merchandise would fall within the definition of being a liquid. For example, a squeezable bottle of a skin moisturizer gel would be considered a container of duty free liquid merchandise requiring inspection.

At step 502, a machine readable tag conveying identification information related to the duty free liquid merchandise purchased at step 500 is generated. In specific embodiments, a separate machine readable tag may be generated for each container of duty free liquid merchandise purchased wherein each tag conveys identification information associated with a respective container of duty free liquid merchandise. Alternatively a single machine readable tag may be associated with multiple containers of duty free liquid merchandise purchased in a transaction and may convey identification information associated with the containers of duty free liquid merchandise.

The machine readable tag generated at step 502 conveys identification information pertaining to the duty free liquid merchandise. This identification information generally identifies expected content of the duty free liquid merchandise and is associated with an expected response to penetrating radiation associated with the duty free liquid merchandise. The expected response of the liquid merchandise to penetrating radiation can include any number of features associated with the duty free liquid merchandise such as, for example:
the number of containers of liquid in the duty free liquid merchandise;
for each container of liquid in the duty free liquid merchandise:
   a. features associated with the nature of the liquid within the container including, for example:
      i. the density of the liquid(s) contained within the container;
      ii. The effective atomic number (also known as the Z_{eff} number) of the liquid within the container
   b. geometric information associated with the container including;
      i. the general shape of the container of the duty free liquid merchandise, such as cylindrical, square or rectangular, among others;
      ii. distinguishing features of the container, such as whether its contour tapers towards one end (e.g. a wine bottle).

It will be appreciated that the above list of features has been presented for the purpose of illustration only and that certain features may be omitted from and additional features added to the above list in alternate embodiments of the invention.

The expected response of the liquid merchandise to penetrating radiation can be encoded directly in the machine-readable tag and forms part of the identification information. Alternatively, the identification information may constitute a reference (or a pointer) to an external source of information, such as an external memory device, where the expected response of the liquid merchandise to penetrating radiation is stored.

At step 504, the machine readable tag is associated with the duty free liquid merchandise. This association between the machine readable tag and the duty free liquid merchandise may be made in a number of different manners.

In a first specific example, each machine readable tag generated is associated with the duty free liquid merchandise by either fastening it directly to the containers of liquid part of the duty free liquid merchandise or to a receptacle that is holding the duty free liquid merchandise.

In a second specific example, rather than directly associating the machine readable tag and the duty free liquid merchandise, the association between the machine readable tag and the duty free liquid merchandise may be indirect, for example by associating the machine readable tag with the passenger who purchased the duty free liquid merchandise. This association can be made in a number of different suitable manners. In a first embodiment, the association may be made logically by including in the machine readable tag, in addition to identification information related to the duty free liquid merchandise, information related to the identity of the passenger (e.g. passenger name, passport number, flight information (airline, flight no., seat number, gate)) that could be used by airport security personnel to positively associate a passenger with duty free liquid merchandise. In a second embodiment, the association may be made physically by affixing or otherwise attaching the machine readable tag to a document carried by the passenger during travel. Examples of such documents include, without being limited to, the passenger's boarding pass and the passengers' passport. In a third embodiment, the association may be made both logically and physically by including in the machine readable tag information related to the identity of the passenger as well as attaching the machine readable tag to a document carried by the passenger during travel.

It will be readily appreciated by the person skilled in the art that the machine readable tag need not be a separate physical component but may be embedded within another component used by the passenger during travel. In a non-limiting example of implementation, the identification information related to the duty free liquid merchandise may be stored within a passenger's existing RFID-equipped passport, boarding pass, smart card or other suitable medium.

Advantageously this alternative embodiment would allow passengers to purchase duty free liquid merchandise without worrying about losing the machine readable tags required to screen their purchased liquid merchandise as well as allowing airport security personnel to positively associate duty free liquid merchandise with respective passengers.

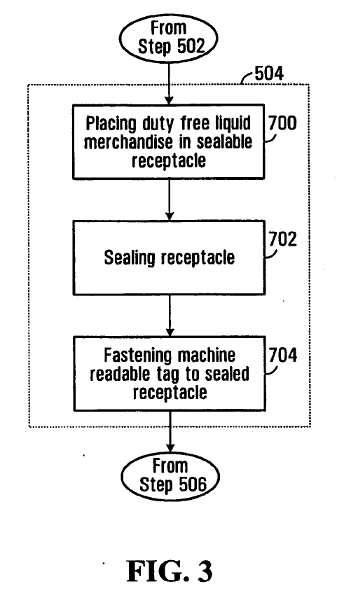

A specific non-limiting example of implementation of step 504 is shown in greater detail in FIG. 3 of the drawings.

At step 700, the one or more containers of duty free liquid merchandise are placed in a sealable receptacle. Any suitable type of sealable receptacle may be used. Two examples of sealable receptacles that could be used to store containers of duty free liquid merchandise are sealable bags and lockable boxes. In implementations where the receptacle is a sealable bag, the sealable bags would be made from a material that is substantially transparent to penetrating radiation and that would include a sealing mechanism (e.g. a strip of double-sided tape or glue on a flap) that would be sealed subsequent to the insertion of the container(s) of duty free liquid merchandise. Such a sealing mechanism would allow the bag to be sealed subsequent to the duty free liquid merchandise being placed in the bag so that no additional items may be placed within the bag prior to subjecting the duty free liquid merchandise to penetrating radiation.

In implementations in which the receptacle is a lockable box, the lockable boxes would be made from a material that is substantially transparent to penetrating radiation and that would include a locking mechanism (e.g. a keyed lock integrated in a hinged side) for locking and unlocking the box. Such a locking mechanism would allow the box to be sealed subsequent to the duty free liquid merchandise being placed in the box so that no additional items may be placed within the box prior to subjecting the duty free liquid merchandise to penetrating radiation.

At step 702, the sealable receptacle is sealed subsequent to the containers being placed within it. This step is for ensuring that no items other than the duty free liquid merchandise may be placed within the receptacle prior to subjecting the merchandise to the penetrating radiation, such as X-rays.

At step 704, the machine readable tag is fastened or otherwise associated with the (now sealed) receptacle holding the duty free liquid merchandise. The machine readable tag may be fastened or otherwise associated with the receptacle, for example, by placing the machine readable tag within the receptacle, attaching the machine readable tag to the receptacle or affixing the machine readable tag on the surface of the receptacle. Once this action is complete, the sealed receptacle with the machine readable tag associated thereto is returned to the passenger who purchased the duty free liquid merchandise so he or she can proceed to the security checkpoint and to step 506 and 508.

At step 506, the identification information is extracted from the machine readable tag. The manner in which the identification information is extracted from the machine readable tag will vary depending on the type of machine readable tag used. For example, if the machine readable tag includes a printed bar code component for conveying the identification information, the identification information is extracted by using a bar code reader device. Alternatively, if the machine readable tag includes an RFID component for conveying the identification information, the identification information is extracted by using an RFID reader device. Alternatively still, if the machine readable tag includes a metallic bar code component for conveying the identification information, the identification information may be extracted by using an x-ray machine and extracting the identification information from an x-ray image of the tag.

At step 508, the duty free liquid merchandise is subjected to penetrating radiation in order to obtain an x-ray image of the duty free liquid merchandise. In a specific implementation, this step includes placing the duty free liquid merchandise on a conveyor belt of an x-ray screening device and subjecting the duty free liquid merchandise to penetrating radiation.

The duty free liquid merchandise is either placed directly on the conveyor belt of the x-ray scanning equipment or in a designated receptacle for scanning, such as a tray, which is then placed on the conveyor belt of the x-ray scanning equipment. Optionally, the duty free liquid merchandise may be scanned while it remains within a sealed receptacle, such as a bag or box, that is substantially transparent to x-rays or may be removed from the receptacle prior to scanning.

The conveyor belt is used to transport the duty free liquid merchandise to the area where it may be subjected to penetrating radiation. When the designated receptacle and its contents arrive at the area where they can be subjected to penetrating radiation, the duty free liquid merchandise is subjected to penetrating radiation (such as X-rays). The result of this action is the generation of a resulting image (such as an X-ray image) of the duty free liquid merchandise.

It is worth noting that steps 506 and 508 may occur concurrently or sequentially, depending on the type of machine readable tag and/or the component used to convey identification information about the containers of duty free liquid merchandise. For example, if machine readable tags use copper barcodes to convey identification information about duty free liquid merchandise, the copper barcode conveying the identification information will appear on the resulting X-ray image generated along with the duty-free liquid merchandise, since the metal components of the barcode are opaque to the penetrating radiation. In addition, if machine readable tags use RFID components for conveying the identification information, the RFID reader may be positioned within the x-ray machine tunnel and therefore when the conveyor belt transports the duty free liquid merchandise to the area where it may be subjected to penetrating radiation, it also transports the tag in the vicinity of the RFID reader so that the identification information may be extracted from the tag.

At step 510, the identification information extracted at step 506 is used in conjunction with the X-ray image of the duty free liquid merchandise obtained at , step 508 to determine if information conveyed by the x-ray image of the duty free liquid merchandise is consistent with the extracted identification information.

More specifically, an observed response of the liquid merchandise to penetrating radiation may be extracted from the X-ray image of the duty free liquid merchandise obtained at step 508 while an expected response of the liquid merchandise to penetrating radiation may be obtained based on the identification information. At step 510, it is determined whether the observed response is consistent with the expected response of the liquid merchandise to penetrating radiation.

It is to be appreciated that consistency between an observed response and an expected response to penetrating radiation does not require an exact match between these responses. Rather, consistency between the observed response and the expected response to penetrating radiation can be found when differences between these responses are less than some acceptable level of variation. It will be appreciated by the person skilled in the art that what is deemed to be an “acceptable level of variation” may vary from one specific implementation to the other. In addition, what is deemed to be an “acceptable level of variation” may depend on external circumstances such as, for example, a national security threat level, the profile of the passenger to name but a few. Consistency between the observed response and the expected response to penetrating radiation may be determined based on the use of empirical and /or heuristic rules to compare various features of the observed response with corresponding features of the expected response.

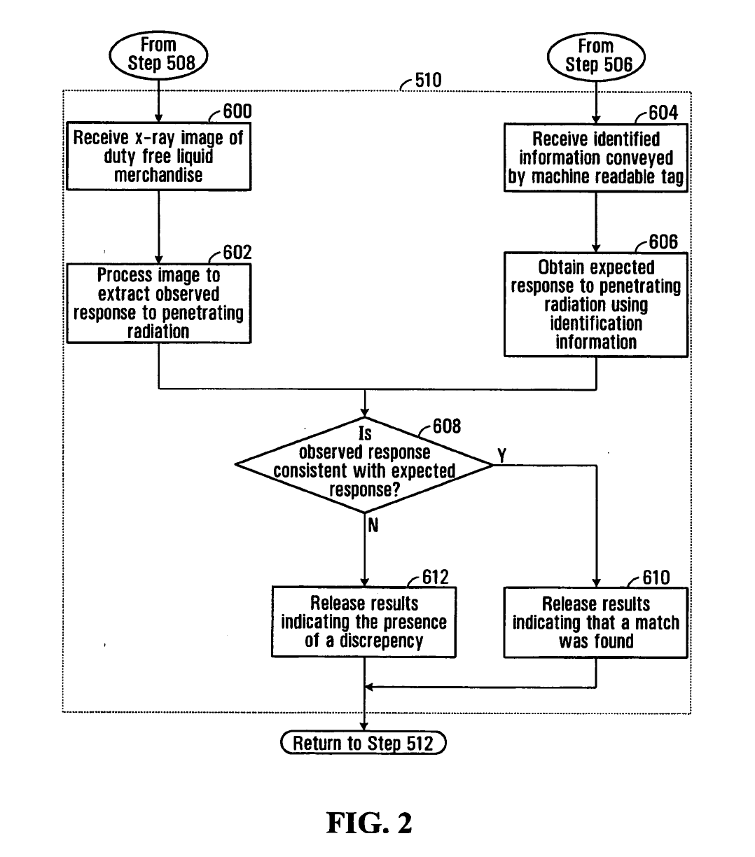

A specific example of implementation of step 510 is shown in greater detail in FIG. 2 of the drawings.

At step 600, the image of the duty free liquid merchandise generated at step 508 is received at step 602, the X-ray image of the duty free liquid merchandise is processed to derive an observed response to penetrating radiation associated with the duty free liquid merchandise. The observed response of the liquid merchandise to penetrating radiation can include any number of features associated with the duty free liquid merchandise that may be extracted from the x-ray image such as, for example:
the number of containers of liquid in the duty free liquid merchandise;
for each container of liquid in the duty free liquid merchandise:
   a. features associated with the nature of the liquid within the container including, for example:
      i. the density of the liquid(s) contained within the container;
      ii. The effective atomic number (also known as the Z_{eff} number) of the liquid within the container
   b. geometric information associated with the container including;
      i. the general shape of the container of the duty free liquid merchandise, such as cylindrical, square or rectangular, among others;
      ii. Distinguishing features of the container containing the duty free liquid merchandise.

The features related to geometric information associated with each container may be derived from the x-ray image of the duty free liquid merchandise using any suitable method. Since such methods are known in the art, they will not be described further here.

Similarly, the features associated with the nature of the liquid within the container may be derived from the x-ray image of the duty free liquid merchandise using any suitable method. Examples of methods that could be used are described in international patent application no.: PCT/CA2007/001658, “Method and Apparatus for Assessing the Characteristics of Liquids”, which was filed by Optosecurity et al. with the Canadian Receiving Office on Sep. 17, 2007 and was published on Mar. 27, 2008 under publication no. WO2008034232. The aforementioned document is incorporated herein by reference.

It should be understood that the above examples of features that may be extracted from the x-ray image have been presented for the purpose of illustration only and that other suitable embodiments are possible within the scope of the present invention.

At step 604, the identification information extracted at step 506 is received and at step 606, the X-ray image of the duty free liquid merchandise is processed to obtain an expected response to penetrating radiation associated with the duty free liquid merchandise.

For embodiments in which the expected response of the liquid merchandise to penetrating radiation is encoded directly in the machine-readable tag and forms part of the identification information, step 606 does not require any specific additional action. As such, the process proceeds to step 608.

For embodiments in which the identification information constitutes a reference (or a pointer) to an external source of information, such as a knowledge bank stored on a memory device, where the expected response of the liquid merchandise to penetrating radiation is stored, step 606 includes accessing the knowledge bank to locate and extract therefrom information corresponding to the identification information, the extracted information conveying the expected response of the duty free liquid merchandise to penetrating radiation.

At step 608, a determination is made whether the observed response to penetrating radiation obtained at step 602 is consistent with the expected response to penetrating radiation obtained at step 606. In a specific example of implementation, this step includes comparing the observed response to penetrating radiation of each container of liquid part of the duty free liquid merchandise to its expected response penetrating radiation and determine whether any unacceptable variations are present. The acceptable variations used in determine consistency may be determined empirically and may depend upon the nature of the liquid itself. In a specific example of implementation, the acceptable variations are part of the expected response to penetrating radiation.

Different rules for determining whether an observed response to penetrating radiation of a given container of liquid is consistent with its expected response penetrating radiation may be contemplated. For example, a simple rule may state that:

For a given container:
A) the observed response to penetrating radiation is consistent with the expected response penetrating radiation if,
   The observed geometric dimensions of the container are within an acceptable range of the expected geometric dimensions of the container; and
   the observed density and/or effective atomic number of the liquid in the container are/is within acceptable ranges of the expected value(s)
B) otherwise, the observed response to penetrating radiation is deemed to be inconsistent with the expected response penetrating radiation. This indicates the liquid in the container may not be what it claims to be and has either been replaced or otherwise modified.

It is to be appreciated that the above example of a rule for determining whether an observed response to penetrating radiation of a given container of liquid is consistent with its expected response penetrating radiation was presented for the purpose of illustration only and it is to be appreciated that actual implementations may make use of different and more complex sets of rules without detracting from the spirit of the invention. Essentially the purpose of these rules is to determine whether the observed response to penetrating radiation is sufficiently close to the expected response to conclude that the duty free liquid merchandise contains what it is expected to contain. It is to be appreciated that the specific rules and methods used to determine consistency between an expected and an observed response to penetrating radiation are not critical to the invention.

If at step 608 it is determined that the observed response to penetrating radiation is consistent with the expected response to penetrating radiation, we proceed to step 610. Alternatively, if at step 608 it is determined that the observed response to penetrating radiation is not consistent with the expected response to penetrating radiation, we proceed to step 612.

At step 610, results indicating that the observed response of the liquid merchandise to the penetrating radiation is consistent with the expected response for this liquid merchandise are released. Once step 610 is completed, the process then continues to step 512 (shown in FIG. 1).

At step 612, results indicating the presence of a discrepancy between the observed response of the liquid merchandise and the expected response are released. Optionally, the results released at step 612 may include varying amounts of details related to the reason (or reasons) for the discrepancy. For example, in situations where the duty free liquid merchandise include two (2) or more containers of liquid, the results may specify which container(s) of liquid was (were) at the root of concluding there was a discrepancy. In another example, the results may specify, for a given container of liquid part of the duty free liquid merchandise, what feature(s) found in the observed response to penetrating radiation was (were) found to be inconsistent with the expected response to penetrating radiation. Once step 612 is completed, the process then continues to step 512 (shown in FIG. 1).

Returning to FIG. 1, at step 512 the results of the determination made at step 510 are conveyed to a security screener. The results may be conveyed in a number of manners including for example:
a) by displaying information on a display screen via a user interface, the information displayed conveying the results obtained at step 510; and/or
b) by using audio queues to convey the presence (and/or absence) of a discrepancy between the x-ray image and the identification information;
c) by combinations of a) and b) described above.

If the result of this comparison indicates that the x-ray image is consistent with the identification information, the security screener may allow the passenger to proceed with the duty free liquid merchandise without further inspection. On the other hand, if the result of this comparison indicates that the x-ray image is inconsistent with the identification information, the security screener may be prompted to instruct the passenger to proceed to a further inspection station or may confiscate the duty free liquid merchandise.

At step 514, which is an optional step, screening information is stored on a machine readable tag associated with the duty free liquid merchandise.

In a first example of implementation, the screening information may be stored in the same machine readable tag conveying the identification information associated with the duty free liquid merchandise that was generated at step 502. This example of implementation is most conveniently used in situations where the machine readable tag includes a medium that provides write access. For example, an RFID type medium, smart card or other suitable medium may be considered. In such cases, the information on the machine readable tag may be updated by using a suitable device, such as an RFID writer.

In a second example of implementation, the screening information may be stored on a new machine readable tag distinct from the machined readable tag that was generated at step 502.

The screening information that is stored at this step may include any suitable information that was generated or obtained during the screening process and that may be desirable to refer to later on. Examples of information that may be stored include:
The results obtained at step 510 when determining if information conveyed by the x-ray image of the duty free liquid merchandise is consistent with the identification information extracted at step 508;
The x-ray image of the duty free liquid merchandise obtained at step 508
Information conveying the observed response of penetrating radiation associated with the duty free liquid merchandise obtained from the x-ray image of the duty free liquid merchandise;
Information conveying an expected response to penetrating radiation obtained using the identification information extracted at step 506.

Storing the screening information at step 514 may be performed only when the results obtained at step 510 indicate that the duty free liquid merchandise was inconsistent with the identification information conveyed by the machine readable tag. As such, the screening information would be used to identify the passenger to airport security personnel at a later security stage for questioning as to whether the duty free liquid merchandise was replaced and/or tampered with.

In addition, or alternatively, storing the screening information at step 514 may be performed when the results obtained at step 510 indicate that the duty free liquid merchandise was consistent with the identification information conveyed by the machine readable tag. This may indicate that the duty free liquid merchandise for a given passenger were already pre-screened and may expedite security screening at a subsequent security checkpoints.

It is to be appreciated that, in specific implementations of the process depicted in FIG. 1, steps 500, 502 and 504 are likely to take place at a first location, such as at a location associated with a duty free point of sale, while steps 506, 508, 510, 512 and 514 take place at a second location distinct from the first location, such as at a location associated with a security screening checkpoint. For example, the generation of the machine readable tag at step 502 may be made at the same time a receipt for the purchase of the duty free merchandise is generated and therefore may be generated at a duty free point of sale. Alternatively, steps 502 and 504 may be made at an intermediate location between a duty free point of sale and a security checkpoint.

Exemplary System

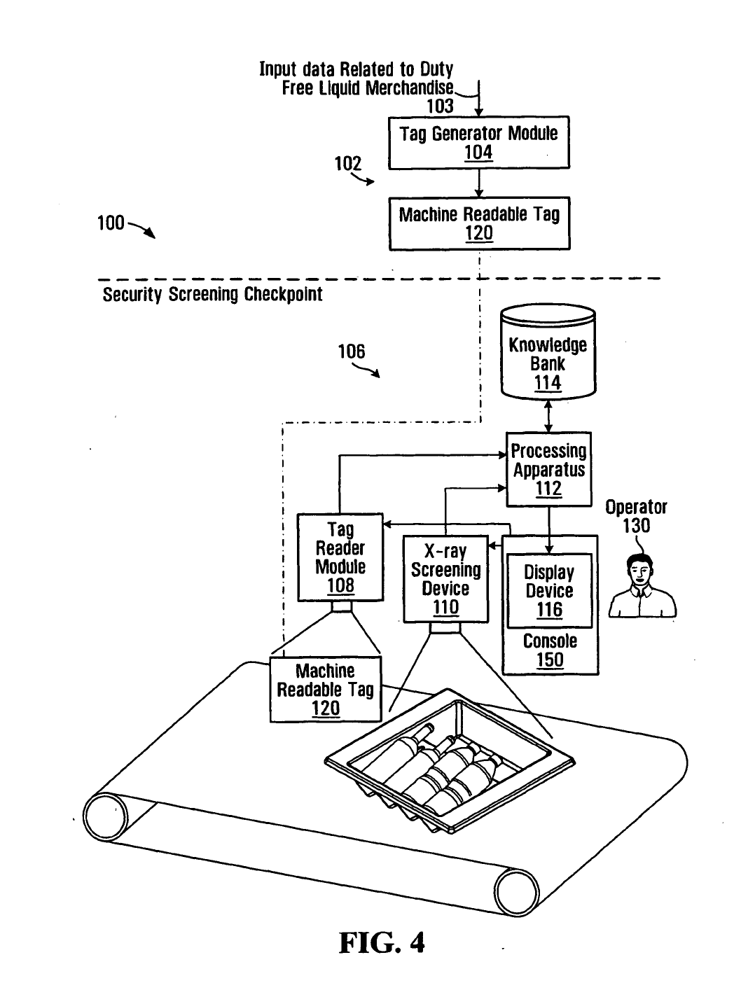

A system for implementing the process depicted in FIGS. 1, 2 and 3, in accordance with a specific example of implementation will now be described with reference to FIG. 4.

As depicted in FIG. 4, the system 100 comprises a tag generator module 104, a tag reader module 108, an x-ray screening device HO, a processing apparatus 112 and a console 150. The system 100 also includes a knowledge bank 114.

Knowledge Bank 114

The knowledge bank 114 stores information conveying expected responses to penetrating radiation associated with respected containers of duty free liquid merchandise.

In a specific example of implementation, the knowledge bank 114 includes a plurality of entries associated with response types of commercially available containers of liquid, each entry storing information pertaining to an expected response to penetrating radiation associated with a type of duty free container of liquid. The expected response of the liquid merchandise to penetrating radiation for each container of liquid can include any number of features associated with the duty free liquid merchandise such as, for example:
A. features associated with the nature of the liquid within the container including, for example:
   the density of the liquid(s) contained within the container;
   The effective atomic number (also known as the Z_{eff} number) of the liquid within the container
B. geometric information associated with the container including;
   the general shape of the container of the duty free liquid merchandise, such as cylindrical, square or rectangular, among others;
   Distinguishing features of the container, such as whether its contour tapers towards one end (e.g. a wine bottle).

It will be appreciated that the above list of features has been presented for the purpose of illustration only and that certain features may omitted from and additional feature added to the above list in alternate embodiments of the invention.

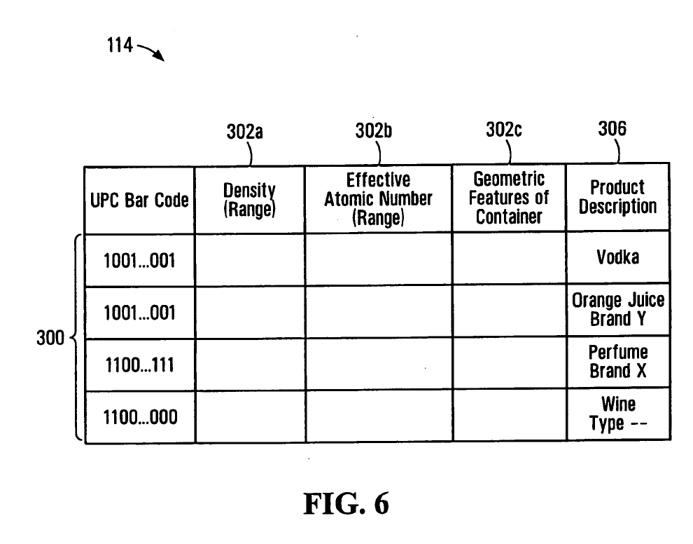

FIG. 6 shows a non-limiting example of the knowledge bank 114, as well as examples of the types of information that may be stored within it. In this example, the knowledge bank 114 is comprised of a set of entries 300 that are organized by their UPC barcode numbers. Each entry is comprised of a set of features (a Density feature 302a, an Effective Atomic Number feature 302b and a Geometric Features of Container 302c), as well as a product description 306.

In the exemplary system depicted in FIG. 4, the knowledge bank is shown as being in communication with processing apparatus 112 and as being used in association with a security screening checkpoint. In alternative examples of implementation (not shown in the figures), the knowledge bank 114 may instead be in communication with the tag generator module 104 and may be used, for example, in embodiments in which the expected response to penetrating radiation is encoded directly on the machine readable tag as part of the identification information.

Optionally, in order to increase the usefulness of the system, the knowledge bank may be updated periodically so that its content remains current. Specifically, the knowledge bank 114 can be updated periodically to reference new duty free liquid merchandise that are being released on the market and that are susceptible to be carried by passengers through the security checkpoint.

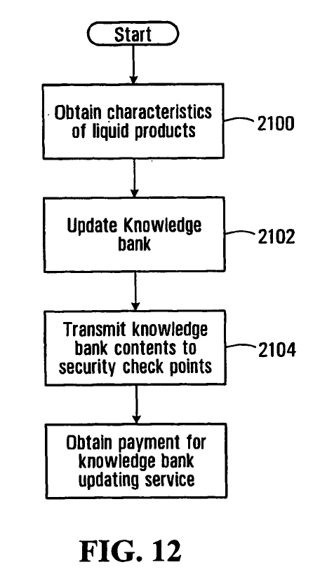

The knowledge bank updating information is illustrated by the flowchart on FIG. 12. Initially, a list is obtained on the new liquid products that will be sold at duty free security checkpoints and that should be loaded in the knowledge bank 114. This can be done in various ways. Once the list of those products is set, then samples are obtained. At step 2100 the samples are processed to extract the relevant data (product's expected response to penetrating radiation). The relevant data is then loaded in the knowledge bank 114, at step 2102.

The knowledge bank 114, either in its entirety or only the updated part is transmitted either to duty free points of sale or, alternatively, to the various locations that use it to perform security screening. The transmission can be done electronically, such as over the Internet or manually by recording the update on a portable machine readable medium, which is then loaded in a reader on the computer that manages the knowledge bank 114. This operation is shown at step 2104. The number of locations that need to be updated will depend upon the manner in which the individual security checkpoints and/or duty free point of sale work. If each security checkpoint/duty free point of sale is a stand alone unit and has its own knowledge bank 114, then each security checkpoint/duty free point of sale has to be updated individually. On the other hand, if the security checkpoints/duty free point of sale are networked, a more automated updating procedure is possible. For instance, if the network is such that a common knowledge bank 114 is provided which services a plurality of security checkpoints, then a single update is sufficient. On the other hand, if the networked arrangement uses a plurality of knowledge banks local to the respective security checkpoints, then the data to perform the update can be electronically sent in the field to the various security checkpoints to make local updates.

The knowledge bank update would normally be in the form of a subscription or available on demand. In this fashion the entity that performs the knowledge bank 114 update will charge the end user (government entity or private contractor or duty free merchant) for the updates. The financial arrangements can vary and many may be in the form of a fixed fee arrangement valid for a predetermined time period, say one year. During the subscription period, the end user receives automatic updates as soon as they become available. When the update is done on demand, then an update is sent only when requested and a payment is made by the end user after reception of the service.

Tag Generator Module 104

Returning now to FIG. 4, the tag generator module 104 is used to generate a machine readable tag 120 conveying identification information associated with duty free liquid merchandise purchased at a duty free point of sale, such as a duty free store in an airport. The tag generator module 104 may be located at the duty free point-of-sale so that the machine readable tag 120 is generated when a passenger purchases the duty free liquid merchandise. The module 104 may also be located at any other suitable location between the duty free point of sale and the security screening checkpoint, such as at a central warehouse location where duty free purchases (including liquid merchandise) are prepared before being supplied to their associated passengers.

The tag generator module 104 generates the machine readable tag 120 containing a component to convey identification information associated with the liquid merchandise.

The tag generator module 104 may generate a separate machine readable tag for each container of duty free liquid merchandise purchased, wherein each tag conveys identification information associated with a respective container of duty free liquid merchandise. Alternatively, the tag generator module 104 may generate a single machine readable tag associated with multiple containers of duty free liquid merchandise purchased in a transaction and may convey identification information associated with the multiple containers of duty free liquid merchandise.

The tag generation module 104 generates the machine readable tag 120 based on input data 103 related to the duty free liquid merchandise. The input data 103 may convey different type of information including product information (UPC, product number, product name, etc . . . ) or a reference (or pointer) to a transaction database storing product information associated with purchases made at the duty free point of sale (e.g. a transaction number).

This input data 103 may be obtained by the tag generation module 104 from a number of different sources such as:
From a computing apparatus used at the duty free point of sale during the purchase of the duty free liquid merchandise. In such situations, the tag generation module 104 may include suitable network communication hardware/software for communicating with the computing apparatus used at the duty free point of sale;
From a receipt generated as a result of the purchase of the duty free liquid merchandise. In such situations, the tag generation module 104 may include a suitable input device for reading the information on the receipt;
By providing an input mechanism in communication with the tag generation module (e.g. keyboard, touch sensitive screen and GUI, bar code reader, RFID reader) allowing a person, such as a salesperson at the duty free point of sale, to enter information related to the duty free liquid merchandise purchased;
Any other suitable type of mechanism for entering information related to the duty free liquid merchandise.

The tag generation module 104 processes the input data 103 to generate the machine readable tag 120.

As indicated earlier in the description, the machine readable tag 120 contains a component to convey identification information associated with the liquid merchandise. This identification information is related to an expected content of the duty free liquid merchandise which in turn is associated with an expected response to penetrating radiation associated with the duty free liquid merchandise.

In a first implementation, a reference (or a pointer) to an external source of information where the expected response of the liquid merchandise to penetrating radiation is stored, in this example the knowledge bank 114, is encoded in the machine-readable tag 120. Note that in this first implementation, the knowledge bank 114 would be in communication with processing apparatus 112 as shown in FIG. 4 rather than with tag generator module 104. This reference or pointer forms part of the identification information. In this first implementation, the tag generator module 104 makes use of the input data 103 to generate the identification information. In a simple form, the identification information is substantially the same as the input data 103 and is encoded directly in the machine-readable tag 120. Other manners of providing a reference may also be contemplated by the person skilled in the art without detracting from the spirit of the invention.

In a second implementation, the expected response of the liquid merchandise to penetrating radiation is encoded directly in the machine-readable tag 120 and forms part of the identification information. In this second implementation, the knowledge bank 114 would be in communication with the tag generator module 104 (rather than processing apparatus 112 shown in FIG. 4), and the tag generator module 104 makes use of the input data 103 to locate in the knowledge bank 114 one or more entries corresponding to product information conveyed by the input data 103. Once the one or more entries corresponding to product information conveyed by the input data 103 have been identified, the associated response to penetrating radiation are extracted from the knowledge bank 114 and encoded directly in the machine-readable tag 120 by the tag generator module 104.

The tag generator module 104 is equipped with the required hardware/software components for generating the machine readable tag 120. Depending on the type of machine readable tag to be generated, the tag generator module 104 may comprise the following:
A bar code printing module for printing bar codes on a substrate (e.g. paper), the bar code conveying identification information associated with the duty free liquid merchandise;
A bar code generation device for generating a metallic bar code (e.g. a copper bar code), the bar code conveying identification information associated with the duty free liquid merchandise; or
An RFID writer for storing identification information associated with the duty free liquid merchandise on the RFID component, the RFID component conveying identification information associated with the duty free liquid merchandise.

It should be understood that the above listed devices are exemplary embodiments presented for the purpose of illustration only and that other suitable embodiments are possible.

Machine Readable tag 120

Different types of machine readable tags may be contemplated in specific example of implementations of the invention.

In a first specific example, the machine readable tag includes a barcode component for conveying identification information associated with the duty free merchandise. The bar code component may be in any suitable format such as, for example:
An ink-based barcode, such as a printed (or thermally transferred) barcode that is printed on a paper type substrate; and/or
A metallic barcode, such as a copper barcode created from a copper substrate.

Ink-based barcodes are a simple way to produce and provide a standard barcode sticker that can be affixed to a container of liquid or any other medium so that can be read by a barcode reader at the security screening checkpoint.

Metallic barcodes (such as a copper barcode) provide a way for the identification information encoded within this barcode to be viewed using an X-ray machine, since the metal used to produce the barcode is opaque to penetrating radiation. This allows access to the required identification information without the need for additional equipment (such as a barcode reader).

In yet another embodiment, the machine readable tag may include a rewritable RFID component for conveying identification information related to the duty free liquid merchandise. Optionally, the RFID component of such a tag can also store information about the passenger and the flights the passenger is expected to take.

In yet another embodiment, the machine readable tag may be embedded in a memory of a smart card. This smart card may be a multiple purpose smart card that may be used for example as part of a passport or other identification document and need not be dedicated to the screening of duty free liquid merchandise.

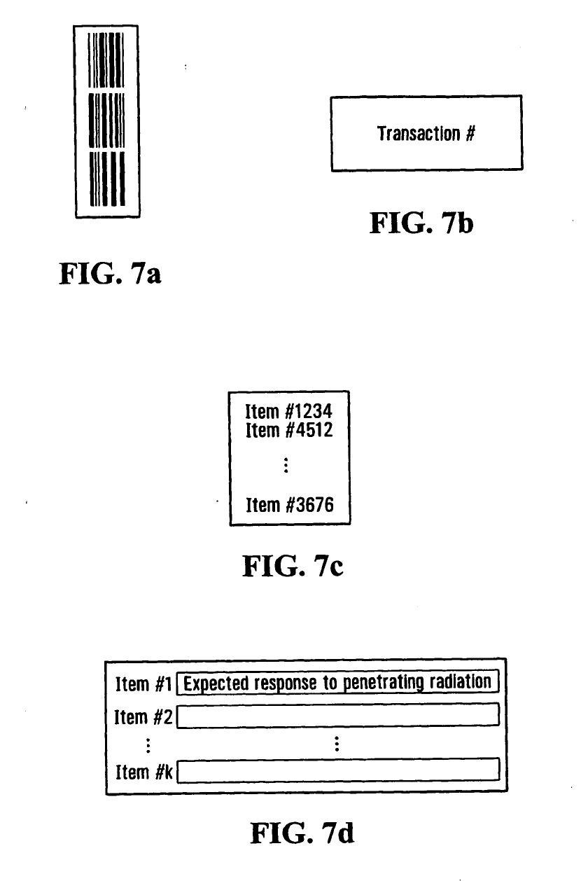

FIGS. 7a, 7b and 7c show sample embodiments of the output of the tag generation module 104 (i.e. a machine readable tag) that could be used to convey identification information related to duty free liquid merchandise. FIG. 7a shows examples of a machine readable tag with barcodes that could be generated to convey identification information about three (3) items of duty free liquid merchandise. FIG. 7b shows an example of a machine readable tag that references a transaction number rather than providing individual identification information for containers of duty free liquid merchandise. The transaction number listed on the tag provides a reference to a transaction record stored on an external memory module (such as a point-of-sale database) where an itemized list of containers of duty free liquid merchandise associated with the transaction is stored. FIG. 7c shows an example of a machine readable tag that lists item numbers associated with the duty free liquid merchandise, where each item number corresponds to an identifier (such as a SKU) for a container of duty free liquid merchandise.

As indicated above, the identification information encoded within the machine readable tag 120 may also include the expected response of its container of duty free liquid merchandise to penetrating radiation. FIG. 7d illustrates such an embodiment. More specifically, FIG. 7d is a representation of a data structure stored in a memory, which may be part of an RFID tag or smart card or other memory medium. This data structure includes a plurality of entries (item #1, item #2 . . . item #k), wherein each entry is associated to a respective container of liquid part of the duty free liquid merchandise and wherein each entry stores information pertaining to a respective expected response to penetrating radiation.

It will be appreciated that the above exemplary embodiments of machine readable tags have been presented for the purpose of illustration only and that several other suitable embodiments are possible within the scope of the present invention.

Returning now to the system shown in FIG. 4, we know consider the components used in connection with a security checkpoint. It is to be appreciated that the component in connection with a security checkpoint may be located in the same terminal and/or airport as the one in which the tag generation module is located or, alternatively, may be located in a different terminal and/or airport.

X-Ray Screening Device 110

The X-ray screening device 110 is adapted for subjecting objects (including duty free liquid merchandise) to penetrating radiation and generating an image signal containing an X-ray image of these objects. In an airport setting, a passenger may place the duty free liquid merchandise 122 into a designated receptacle or tray, which is then placed on a conveyor belt that causes the duty free liquid merchandise to enter a screening area of the x-ray screening device 110. Within this area, the screening device 110 subjects the duty free liquid merchandise to penetrating radiation to generate an X-ray image of the duty liquid merchandise. The X-ray screening device 110 then sends an output signal containing the generated X-ray image to the processing apparatus 112.

In a non-limiting example, the X-ray screening device 110 is embodied as a conventional dual-energy X-ray apparatus of the type typically found in airports. The X-ray screening device 110 may also be a single view x-ray device generating an x-ray image taken from one angle or, alternatively, may be a multi-view x-ray device generating x-ray images taken from multiple angles.

Tag Reader Module 108

The tag reader module 108 is adapted to read the machine readable tag 120 associated with the duty free liquid merchandise. The module 108 includes the required hardware/software components to read the component on the machine readable tag 120 (e.g. barcode or RFID component) conveying the identification information associated with the containers of duty free liquid merchandise being screened. The tag reader module 108 then sends an output signal containing the identification information associated with the machine readable tag 120 to the processing apparatus 112.

The tag reader module 108 may be integral to the X-ray screening device 110 (e.g. for copper barcodes that appear in the generated X-ray image when the tag is subjected to penetrating radiation) or may be a separate component from the X-ray screening device 110, such as in a separate RFID reader or barcode reader. In the case where the module 108 is a separate component, it may optionally be integrated within a mobile device that allows a security screener to scan the machine readable tag(s) for duty free liquid merchandise prior to being scanned by the X-ray screening device 110.

Processing Apparatus 112

The processing apparatus 112 receives the output signals from the X-ray screening device 110 and the tag reader module 108 and processes these signal to determine whether the x-ray image generated by the X-ray screening device 110 is consistent with the identification information extracted from the machine readable tag 120 by the tag reader module 108. In a specific example of implementation, processing apparatus 112 implements step 510 described with reference to FIGS. 1 and 2 above.

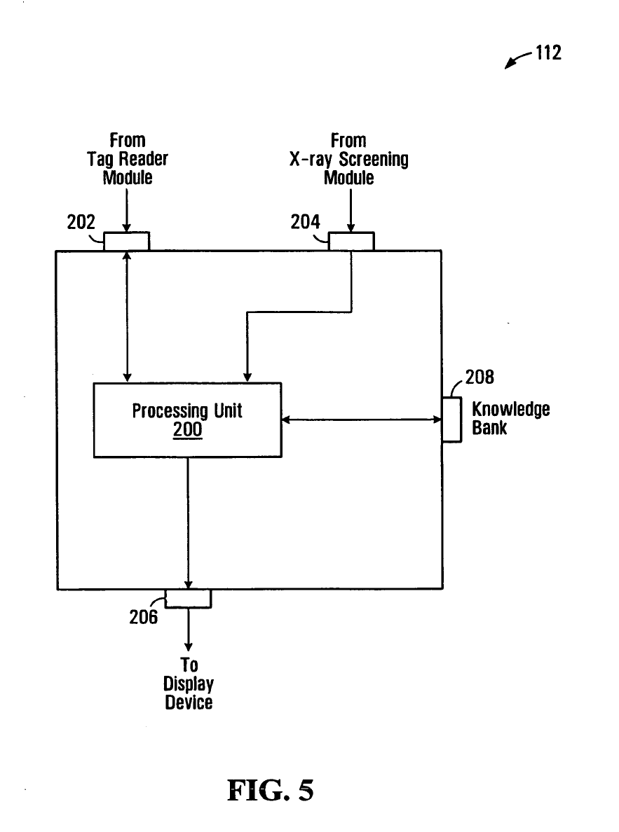

A specific example of implementation of processing apparatus 112 is shown in FIG. 5. As depicted, the processing apparatus 112 includes:
a first input 202 in communications with the tag reader module 108 for receiving identification information related to the duty free liquid merchandise extracted from the machine readable tag 120;
a second input 204 in communications with the X-ray screening device 110 for receiving X-ray data obtained by subjecting the duty free liquid merchandise to penetrating radiation. The X-ray data may convey an X-ray image of the duty free liquid merchandise which may also include the raw data obtained by x-ray screening device 110;
a processing unit 200 for processing an X-ray image received at input 204 and identification information received at input 202 to determine whether the x-ray image is consistent with the identification information;
an output 206 in communication with the processing unit 200 for releasing results obtained by the processing unit 200.

The processing apparatus 112 may include a port 208 for accessing the knowledge bank 114.

The processing unit 200 uses the identification information conveyed by the machine readable tag 120 (such as a reference number) to locate the one or more entries in the knowledge bank 114 associated with the duty free liquid merchandise being screened.

Console 150

As shown in FIG. 4, the processing apparatus 112 is in communication with console 150 for providing the results of the processing so that they can be conveyed to an operator 130, including information related to the results obtained by the processing apparatus 112 when determining if the duty free liquid merchandise is consistent with the identification information. The console 150 can be embodied as a piece of equipment that is in proximity to or remote from the x-ray screening device 110.

The console 150 may comprise suitable software and/or hardware and/or control logic to implement a graphical user interface (GUI) for permitting interaction with the operator 130, including a display device 116. Consequently, the console 150 may provide a control link (not shown) to the x-ray screening device 110, thereby allowing the operator 130 to control motion (e.g., forward/backward and speed) of the conveyor belt and, as a result, to control the position of the x-ray screening device 110.

Exemplary Interaction

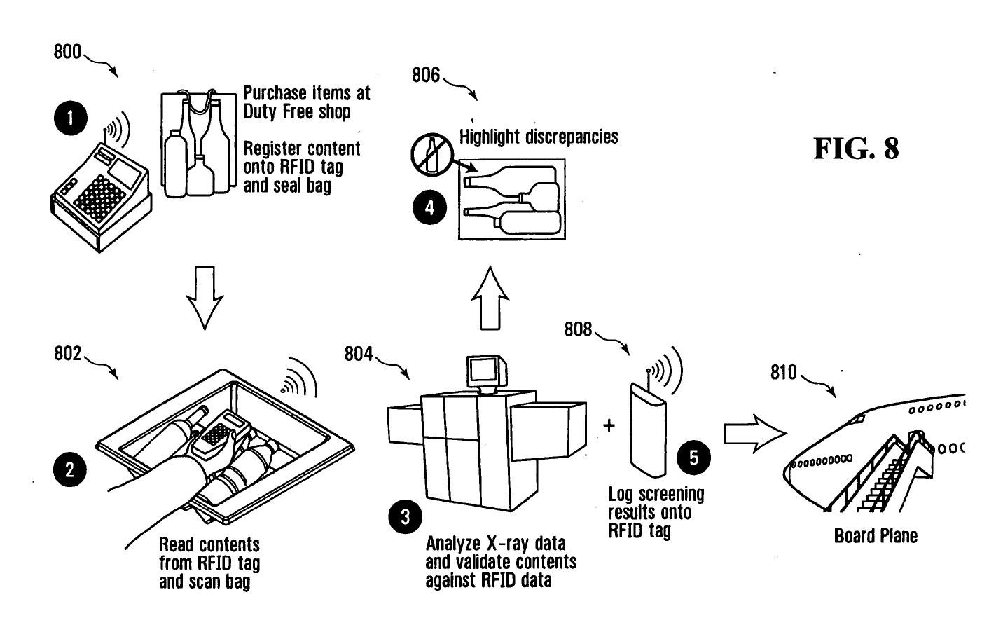

An example of an exemplary screening interaction will now be presented with reference to FIG. 8. For the purpose of simplicity, the following assumptions have been made:
Machine readable tags include an RFID component that can be written to and read from using suitable equipment, such as an RFID reader/writer;
Machine readable tags for purchased duty free merchandise (including liquid merchandise) are generated at the duty free point of sale;
Expected responses to penetrating radiation for duty free liquid merchandise are stored as entries within a knowledge bank accessible by a processing apparatus; and
Results from the screening process are written to the RFID component of the machine readable tags so they can be used elsewhere, such as at other security screening checkpoints in airports where the passenger must catch a connecting flight.

At step 800, the passenger purchases the following four (4) containers of duty free liquid merchandise at a duty free point of sale in an airport, such as a duty free shop:
One (1) 500 ml bottle of Canadian Club® whisky;
One (1) 2 L bottle of Absolut® Vodka;
One (1) 250 ml bottle of Chanel No. (number) 5 perfume;
One (1) 750 ml bottle of 2001 Penfolds® Bin 28 Shiras wine.

At the conclusion of the transaction, a salesperson at the duty free point of sale retrieves the purchased items and places the duty free liquid merchandise in a sealable bag that is suitable for carrying the four (4) items listed above. For illustrative purposes, however, assume that a similarly shaped bottle containing an alcoholic beverage that is different than Absolut® Vodka was mistakenly inserted to and sealed within the sealable bag by the salesperson at the duty free shop.

The salesperson then uses a tag generator module for generating a machine readable tag conveying identification information associated with the four (4) items of duty free liquid merchandise purchased by the passenger. In this case, the tag generator module includes an RFID writer integrated within a point of sale device (e.g. a cash register) that records identification information for the above-listed four (4) items to an RFID component of the machine readable tag. The identification information added to the tag is the form of UPC barcode numbers of the four (4) items purchased, including that for the bottle of Absolut® Vodka. These UPC barcode numbers correspond to specific entries in a knowledge bank for the different types and containers of liquid merchandise purchased by the passenger and will be used in the process later on to obtain the expected responses to penetrating radiation associated with the four (4) items of duty free liquid merchandise.

The sealable bag containing the four (4) items of duty free liquid merchandise is then sealed and the machine readable tag is then fastened to this bag by placing it in a dedicated envelope on its side. Once the bag containing the items is sealed and its machine readable tag fastened, the salesperson returns the sealed bag to the passenger.

At step 802, the passenger has arrived at the security screening checkpoint and has placed the sealed plastic bag containing their four (4) items of duty free liquid merchandise (along with the machine readable tag) within a designated tray for X-ray screening. The airport security screener uses a tag reader module for reading the RFID component of the tag associated with the duty free liquid merchandise. In this case, the tag reader module is a mobile RFID reader that accesses the RFID component of the tag and reads its contents, namely the identification information (i.e. UPC barcode numbers) for each of the four (4) items of duty free liquid merchandise, including that for the bottle of Absolute Vodka.

The identification information read from the machine readable tag for these items of duty free liquid merchandise is communicated to processing apparatus. In this case, the communication between the tag reader module and the processing apparatus is made over a wireless link. Once the machine readable tag has been scanned, the security screener places the sealable bag containing the duty free liquid merchandise within a designated tray that is then placed on a conveyor for transport to an X-ray screening device.

At step 804, the X-ray screening device subjects the duty free liquid merchandise to penetrating radiation to generate an X-ray image of the duty free liquid merchandise. In this case, the X-ray screening device is a conventional dual-energy X-ray apparatus of the type typically found in airports. Although the X-ray screening device used in this non-limiting example is a dual-energy X-ray apparatus, those skilled in the art will appreciate that the present invention is not limited to such an embodiment.

The X-ray screening device scans and generates X-ray image data of the four (4) items of duty free liquid merchandise that were purchased by the passenger. The signal for the X-ray image generated by the X-ray screening device for these items of duty free liquid merchandise is communicated to the processing apparatus. The processing apparatus is programmed to use the identification information in conjunction with the X-ray image of the duty free liquid merchandise to determine if the duty free liquid merchandise is consistent with the identification information.

The processing apparatus is programmed to use the identification information conveyed by the machine readable tag to obtain an expected response to penetrating radiation associated with the duty free merchandise, the expected response being related to the expected content of the duty free liquid merchandise. In this case, the processing apparatus would locate the entries in a knowledge corresponding to the UPC barcode for each of the four (4) items of duty free liquid merchandise being scanned to obtain the expected response for these items to penetrating radiation. In a non-limiting example, for each of the four items, this effective response includes the density (or range of densities considered acceptable), the effective atomic number (or range of atomic numbers considered acceptable) and the information related to geometric features of its container (such as its basic shape and/or any distinguishing features).

The processing apparatus is also programmed to derive the observed response to penetrating radiation based on the x-ray image. Any suitable method could be used at this step to derive the observed response from duty free liquid merchandise, including the liquid detection method disclosed in the patent application PCT CA2007/001658, “Method and Apparatus for Assessing the Characteristics of Liquids” filed by Optosecurity et al. previously mentioned.

The processing apparatus is also programmed to compare the observed response to penetrating radiation (based on the x-ray image) to the expected response to penetrating radiation to determine consistency. The results of this comparison determine if the duty free liquid merchandise being screened is consistent with the identification information conveyed by the machine readable tag. In this case, the processing apparatus would compare the features in the expected response for the perfume (i.e. the density, the effective atomic number, and the geometric features of the container listed for the item in the knowledge bank) to the features in the observed response for the perfume (i.e. its observed density, effective atomic number, and geometric features of the container for the item determined through analysis of the X-ray image) to determine consistency.

It may be recalled that the bottle of Absolute Vodka that the passenger had purchased was mistakenly replaced with a similar bottle containing a different alcoholic beverage. In this case, a comparison of the observed liquid's density and/or its effective atomic number for this beverage by the processing apparatus would identify a substantial shift from the features listed for its expected response from the knowledge bank. If the magnitude of this shift is greater than a pre-determined value defined for such liquids, the processing apparatus identifies the liquid contained within this container as being inconsistent with its expected response.

It is worth noting that the process described above by which the processing apparatus obtained the features for the expected response of the item of duty free liquid merchandise to penetrating radiation and then compared these features to the features in the observed response to determine consistency was applied to one (1) of the four (4) items of the duty free liquid merchandise. A similar process would be used with each of the remaining three (3) items to determine if the remaining duty free liquid merchandise is consistent with their respective identification information.

At step 806, a display device that is in communications with the processing apparatus displays information related to the results obtained when determining if the duty free liquid merchandise is consistent with the identification information. In this case, the display device is used to show the results of the comparison by the processing apparatus between an item's expected response and its observed response. Should the processing apparatus identify any inconsistency in the item(s) of duty free liquid merchandise, it sends an output to the display device (and more specifically, to a graphical user interface that appears on the display device) to alert airport security personnel so that further investigations of the discrepancy can be performed.

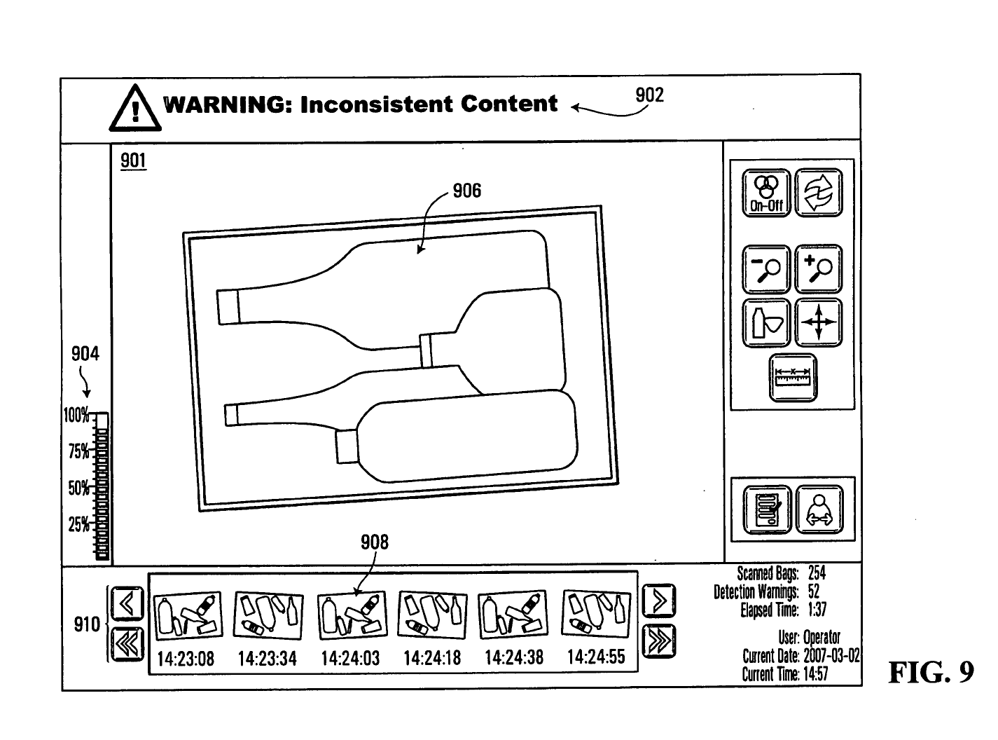

FIG. 9 shows a non-limiting embodiment of such a graphical user interface (GUI) implemented in accordance with the non-limiting example of implementation of the invention described above. The GUI pictured here is comprised of the following components:
A main viewing area 901 where the X-ray image is displayed;
A message area 902 that displays a message describing the results of the comparison that also conveys the threat level and/or handling recommendation;
A threat probability scale 904 that conveys the likelihood that an inconsistency was positively detected in a container and/or among the one or more containers of duty free liquid merchandise;
A “history bar” 908 that shows a plurality of thumbnail images associated with respective previously screened receptacles;
A set of controls 910 that may be used to navigate through the plurality of records shown in the history bar 908 and to manipulate the image displayed in the main viewing area 901.

It will be appreciated that the above exemplary embodiments of GUI components have been presented for the purpose of illustration only and that several other suitable embodiments and/or arrangements of these components of GUI elements are possible.

The GUI displays an X-ray image in the main viewing area 901 of the display. Additionally, the GUI displays a warning message in the message area 902 if the results of the comparison performed by the processing apparatus for the duty free liquid merchandise indicate that there is an inconsistency between the identification information conveyed by the machine readable tag and the x-ray image of the item of liquid merchandise. In the example shown here, the size of the shift between the feature in the expected response and the feature in the observed response exceeded the predetermined level, resulting in a warning message (such as “WARNING: INCONSISTENT CONTENT”) being displayed in the message area 902 of the GUI. It is also conceivable that some other type of signal may be used in conjunction with this message to alert security personnel, such as an auditory alarm that is simultaneously sounded when certain messages. (such as warning messages) appear in the message area 902.

Additionally, the GUI may display the X-ray image in the main viewing area 901 in such a way as to emphasize one or more containers of liquid that have observed responses that are inconsistent with the identification information conveyed by the machine readable tag. The container of liquid may be emphasized in any suitable manner, such as through the use of colors, shading and/or highlighting. In this example, the main viewing area 901 is displaying a collection of containers with each holding a liquid. Moreover, the container of liquid 906 is highlighted in a particular color (such as red) to indicate the processing apparatus has determined that the observed responses of the liquid in that container is inconsistent with the identification information conveyed by its machine readable tag.

Returning now to FIG. 8, when at step 804 it is determined that the shifts for the density and/or the Z_{eff} number between the expected response for the Absolute Vodka and the observed response for the liquid contained within the mistakenly inserted bottle of alcoholic beverage exceeds the pre-determined level, the thumbnail images sends a signal to the display device that causes it to show the message “WARNING: INCONSISTENT CONTENT” within the message area 902 of the GUI (shown in FIG. 9). The processing apparatus may also identify the container of duty free liquid merchandise (i.e. the bottle of alcoholic beverage that was mistakenly inserted to the sealed bag) that caused the inconsistency, such as by highlighting it in red. As a result, the processing apparatus can alert airport security personnel that further investigation of the duty free liquid merchandise is required, as well as identifying the container with the inconsistency that caused the message. This saves time for airport security personnel by directing them to the particular container of the item of duty free liquid merchandise requiring investigation.

Elements of the GUI illustrated in FIG. 9 (such as the X-ray image 901 message area 902) show the case where the result of the comparison of the expected and observed responses for a container of duty free liquid merchandise revealed inconsistencies between the identification information and the duty free liquid merchandise. However, in cases where the identification information conveyed by the machine readable tag is consistent with the duty free liquid merchandise, the message area may display no message, or show an alternative message such as “NO INCONSISTENCY DETECTED-SEARCH AT YOUR DISCRETION”.

At step 808, an output module stores screening information on the machine readable tag. In a non-limiting implementation, an RFID writer connected to the processing apparatus is now used to update the information stored on the machine readable tag for the duty free liquid merchandise with the results of the comparison to indicate that the liquid merchandise is not consistent with to the identification information in the machine readable tag. Information regarding the expected and/or observed response to penetrating radiation associated with the duty free liquid merchandise may also be added to the tag so that it may be used by a system at another security screening checkpoint, such as at a checkpoint in an airport where the passenger must catch a connecting flight.

At step 810, the passenger boards the plane with their inspected duty free liquid merchandise. It is worth noting that should the passenger be required to catch a connecting flight in another airport, steps 802, 804, 806 and (optionally) 808 may be repeated to inspect their duty free liquid merchandise at a security screening checkpoint in this other airport.

Specific Physical Implementation

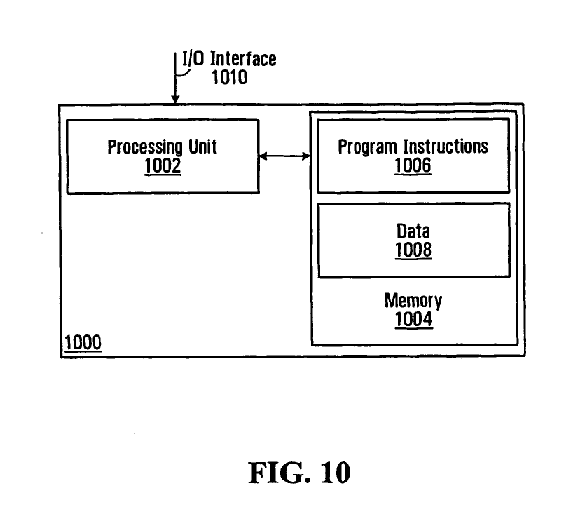

Those skilled in the art should appreciate that certain portions of the process for facilitating the inspection of duty free liquid merchandise (described with reference to FIGS. 1 and 2), and in particular steps 510 and 512 (shown in FIG. 1), can be implemented on a general purpose digital computer 1000, of the type depicted in FIG. 10, including a processing unit 1002 and a memory 1004 connected by a communication bus. The memory includes data 1006 and program instructions 1006. The processing unit 1002 is adapted to process the data 1008 and the program instructions 1006 in order to implement the functional blocks described in the specification and depicted in the drawings. The digital computer 1000 may also comprise an 1/0 interface 1010 for receiving or sending data elements to external devices.

In addition, above-described processing apparatus 112 can be implemented on a dedicated hardware platform where electrical/optical components implement the functional blocks described in the specification and depicted in the drawings. Specific implementations may be realized using ICs, ASICs, DSPs, FPGA, an optical correlator, digital correlator or other suitable hardware platform.

Other alternative implementations of the processing apparatus 112 can be implemented as a combination of dedicated hardware and software. Such an implementation comprises dedicated image processing hardware module and a general purpose computing unit including a CPU and a memory connected by a communication bus.

It will be appreciated that the screening system depicted in FIG. 4 may be of a distributed nature where the X-ray images of duty free liquid merchandise are obtained at one location or more locations and transmitted over a network to a server unit implementing the functionality of the processing apparatus 112 described above. The server unit may then transmit a signal for causing a display device to display information to the user. The display device may be located in the same location where the images of duty free liquid merchandise were obtained or in the same location as the server unit or in yet another location. In a non-limiting implementation, the display device is part of a centralized screening facility.

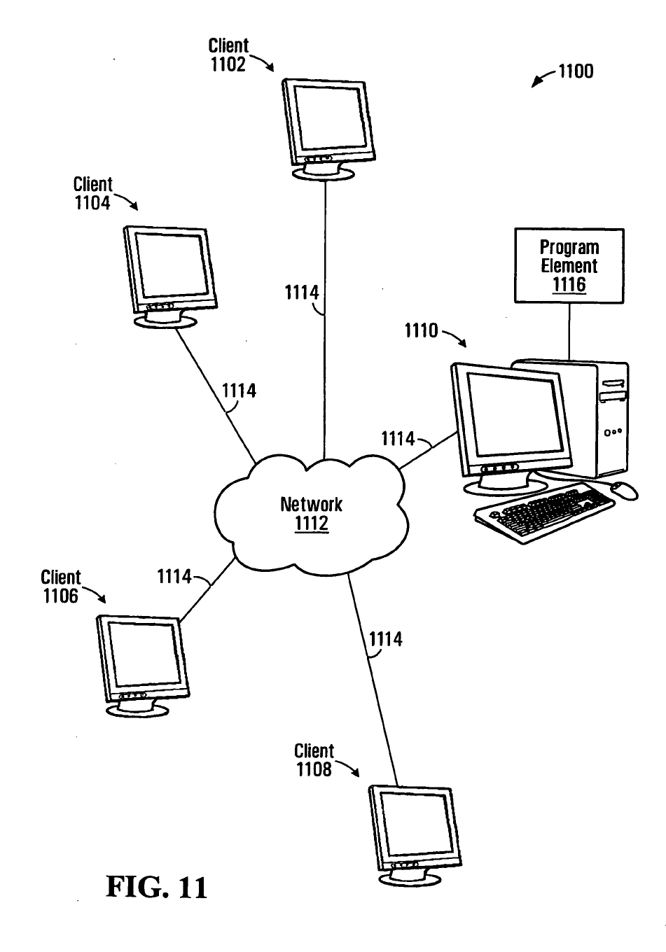

FIG. 11 illustrates a network-based client-server system 1100 for system for use in the inspection of duty free liquid merchandise. The client-server system 1100 includes a plurality of client systems 1102, 1104, 1106 and 1108 connected to a server system 1110 through a network 1112. The communication links 1114 between the client systems 1102, 1104, 1106 and 1108 and the server system 1110 can be metallic conductors, optical fibres or wireless, without departing from the spirit of the invention. The network 1112 may be any suitable network including but not limited to a global public network such as the Internet, a private network and a wireless network. The server 1110 may be adapted to process and issue signals concurrently using suitable methods known in the computer related arts.

The server system 1110 includes a program element 1116 for execution by a CPU. Program element 1116 includes functionality implemented by processing apparatus 112 shown in FIG. 4 described above and includes the necessary networking functionality to allow the server system 1110 to communicate with the client systems 1102, 1104, 1106 and 1108 over the network 1112. In a specific implementation, the client systems 1102, 1104, 1106 and 1108 include display devices responsive to signals received from the server system 1110 for displaying a user interface module implementation by the server system 1110.

Although the present invention has been described in considerable detail with reference to certain preferred embodiments thereof, variations and refinements are possible without departing from the spirit of the invention.

For example, although the specific example of implementation described makes reference to liquid merchandise purchased at a duty free point-of-sale, it will be appreciated that the processes and systems describe here may be used in connection with:
other point-of-sale shops located in secure locations (e.g. locations where high security events are taking place);
points-of-distribution located in secure locations.

As another example, although the present invention has been described with reference to the inspection of liquids following a purchase made at a duty free point-of-sale, it will be appreciated that the processes and systems described in the present application may be used for the inspection of liquid merchandise in the supply chain and that inspection of the liquid merchandise may be performed before the liquid merchandise is placed on the shelved at the duty free point-of-sale or other secure sale/distribution location. For example, the bar code of a case of products entering the secured zone may be scanned and an x-ray image of the products obtained and the bar code and x-ray image may be processed in accordance with the methods described in the present application in order to make sure that the right content is entering the secure zone. Taking advantage of the fact that specific goods are normally shipped in the same type of packaging that already contains machine readable information (ex: UPC Code), the information used to associate the content with the interpreted scanned results is already present.

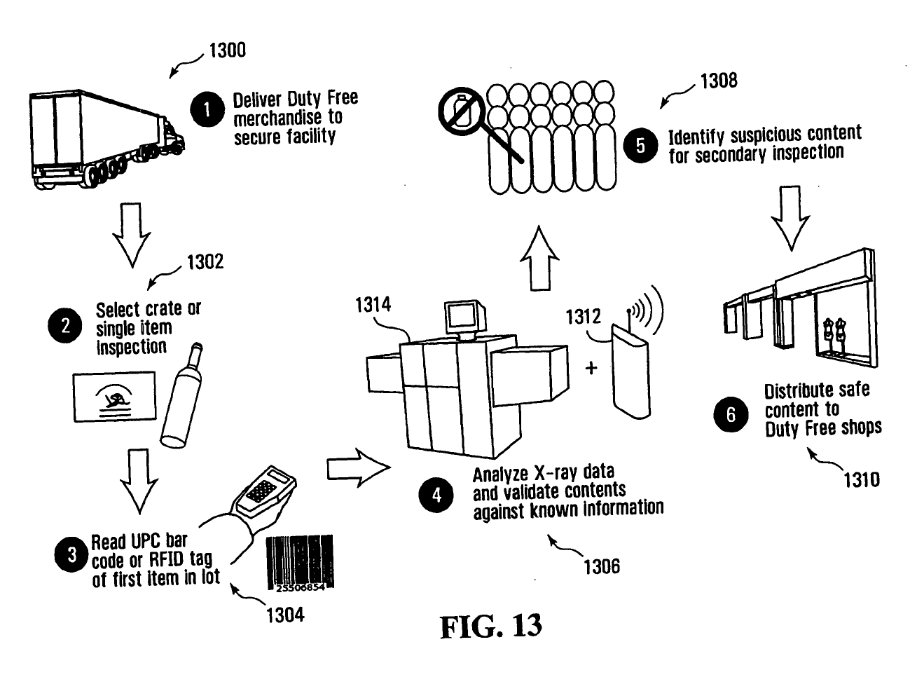

FIG. 13 of the drawings illustrates a specific implementation of such a variant. For the purpose of simplicity, the following assumptions have been made:
The liquid merchandise is associated with a bar code or RFID component;
The bar code or RFID component conveys identification information associated with an expected response to penetrating radiation of the liquid merchandise. The expected response is stored in a knowledge bank accessible by a processing apparatus and is made available at the location at which the inspection takes place.

At step 1300, liquid merchandise is delivered at a secure facility.

At step 1302, a crate, box or single item of the liquid merchandise is selected for inspection purposes. When selecting a single item, the selection is preferably performed randomly to improve security.

At step 1304, a suitable tag reader module (e.g. bar code reader or RFID reader) is used for reading the identification information associated with the liquid merchandise, in this example a UPC bar code component. The identification information read from the machine readable tag is communicated to processing apparatus 1312. Once the bar code component has been scanned, the liquid merchandise is placed on a conveyor for transport to an X-ray screening device 1314.

At step 1306, the X-ray screening device 1314 subjects the liquid merchandise to penetrating radiation to generate an X-ray image of the liquid merchandise. The X-ray image generated by the X-ray screening device 1314 for the liquid merchandise is communicated to the processing apparatus 1312. The processing apparatus 1312 is programmed to use the identification information in conjunction with the X-ray image of the liquid merchandise to determine if the liquid merchandise is consistent with the identification information. The processing apparatus 1312 is analogous to and implements similar functions as the processing apparatus 112 (described with reference to FIG. 4).

At step 1308, a display device that is in communications with the processing apparatus 1312 displays information related to the results obtained when determining if the liquid merchandise is consistent with the identification information. Should the processing apparatus 1312 identify any inconsistency in the liquid merchandise, it sends an output to the display device (and more specifically, to a graphical user interface that appears on the display device) to alert security personnel so that a secondary inspection be performed. If processing apparatus 1312 determines that the liquid merchandise is consistent with the identification information, we proceed to step 1310.

At step 1310, the contents of the liquid merchandise are distributed to the secure sale/distribution location, such as a duty free point-of-sale.

The above variants are but some of many possible variants that will become apparent to the person skilled in the art in light of the present description.

Therefore, the scope of the invention should be limited only by the appended claims and their equivalents.

1. A method for facilitating the inspection of liquid merchandise comprising;
a. generating a machine readable tag conveying identification information related to the liquid merchandise, the machine readable tag being generated in connection with a purchase of the liquid merchandise at a point of sale;
b. associating the machine readable tag with the liquid merchandise;
c. at a security checkpoint, extracting the identification information from the machine readable tag;
d. processing the identification information conveyed by the machine readable tag to obtain an expected response to penetrating radiation associated with the liquid merchandise, the response including at least one feature conveying a characteristic of a liquid substance expected to be contained in the liquid merchandise; and
e. processing the expected response in conjunction with an X-ray image of the liquid merchandise to determine if the liquid merchandise is consistent with the identification information.

2. A method as defined in claim 1, wherein the expected response includes at least one of density information, linear attenuation information and effective atomic number information associated with the liquid substance expected to be contained in the liquid merchandise.

3. A method as defined in claim 1, wherein the expected response includes geometric information associated with a container holding the liquid substance expected to be contained in the liquid merchandise.

4. A method as defined in claim 1, further comprising processing the X-ray image of the liquid merchandise to derive an observed response to penetrating radiation associated with the liquid merchandise, the observed response including at least one feature conveying a characteristic of a liquid substance contained in the liquid merchandise.

5. A method as defined in claim 4, wherein the observed response includes at least one of density information, linear attenuation information and effective atomic number information.

6. A method as defined in claim 1, wherein the liquid merchandise includes one or more containers of liquid.

7. A method as defined in claim 4, said method comprising:
comparing the observed response to penetrating radiation to the expected response to penetrating radiation;
using results of said comparing to determine if the liquid merchandise being screened is consistent with the identification information conveyed by the machine readable tag.

8. A method as defined in claim 7, wherein said method further comprises providing a knowledge bank including entries mapping different types of containers of liquid to one or more features, at least some features conveying expected responses of containers of liquid to penetrating radiation.

9. A method as defined in claim 8, wherein at least some features convey geometric information associated with containers of liquid.

10. A method as defined in claim 8, said method comprising using the identification information conveyed by the machine readable tag to locate one or more entries in the knowledge bank associated with the liquid merchandise.

11. A method as defined in claim 7, said method comprising placing the liquid merchandise on a conveyor belt of an X-ray screening device and subjecting the liquid merchandise to penetrating radiation to obtain the X-ray image of the liquid merchandise.

12. A method as defined in claim 7, wherein said method comprises:
placing the liquid merchandise in a receptacle;
placing the receptacle holding the liquid merchandise on a conveyor belt of an X-ray screening device;
subjecting the liquid merchandise to penetrating radiation to obtain the X-ray image of the liquid merchandise while the liquid merchandise remains in the receptacle.

13. A method as defined in claim 12, wherein associating the machine readable tag with the liquid merchandise includes fastening the machine readable tag to the receptacle holding the liquid merchandise.

14. A method as defined in claim 13, wherein said method further comprises sealing the receptacle so that no items other than the liquid merchandise may be placed within the receptacle prior to subjecting the liquid merchandise to penetrating radiation.

15. A method as defined in claim 14, wherein the receptacle is a bag including a sealing mechanism for sealing the bag subsequent to the liquid merchandise being placed in the bag so that no additional items may be placed within the bag prior to subjecting the liquid merchandise to penetrating radiation.

16. A method as defined in claim 14, wherein the receptacle is a box having a locking mechanism for locking and unlocking the box, the locking mechanism allowing the box to be sealed subsequent to the liquid merchandise being placed in the box so that no additional items may be placed within the box prior to subjecting the liquid merchandise to penetrating radiation.

17. A method as defined in claim 1, wherein the machine readable tag includes an RFID component conveying identification information related to the liquid merchandise.

18. A method as defined in claim 1, wherein said method comprises storing information on the machine readable tag, the information stored being related to the results obtained when determining if the liquid merchandise is consistent with the identification information.

19. A method as defined in claim 1, wherein said method comprises storing screening information on the machine readable tag, the screening information conveying either one of:
an observed response to penetrating radiation associated with the liquid merchandise; or
an expected response to penetrating radiation obtained using the identification information conveyed by the machine readable tag.

20. A method as defined in claim 1, wherein the machine readable tag includes a bar code component.

21. A method as defined in claim 20, wherein the bar code component includes a copper bar code.

22. An apparatus for inspecting liquid merchandise at a security checkpoint, the liquid merchandise being associated with a machine readable tag, the machine readable tag being generated in connection with a purchase of the liquid merchandise at a point of sale, said apparatus comprising;
a first input for receiving identification information related to the liquid merchandise from the machine readable tag;
a second input for receiving an X-ray image of the liquid merchandise derived by subjecting the liquid merchandise to penetrating radiation;
a processing unit in communication with the first input and the second input, said processing unit being programmed for:
processing the identification information to obtain an expected response to penetrating radiation associated with the liquid merchandise, the response including at least one feature conveying a characteristic of a liquid substance expected to be contained in the liquid merchandise;
processing the expected response in conjunction with the X-ray image of the liquid merchandise to determine if the liquid merchandise is consistent with the identification information;
an output in communication with the processing unit for releasing information conveying results obtained by the processing unit when determining if the liquid merchandise is consistent with the identification information.

23. An apparatus as defined in claim 22, wherein the expected response includes at least one of density information, linear attenuation information and effective atomic number information associated with the liquid substance expected to be contained in the liquid merchandise.

24. An apparatus as defined in claim 22, wherein the expected response includes geometric information associated with a container holding the liquid substance expected to be contained in the liquid merchandise.

25. An apparatus as defined in claim 22, wherein said processing unit is further programmed for processing the X-ray image of the liquid merchandise to derive an observed response to penetrating radiation associated with the liquid merchandise, the observed response including at least one feature conveying a characteristic of a liquid substance contained in the liquid merchandise.

26. An apparatus as defined in claim 25, wherein the observed response includes at least one of density information, linear attenuation information and effective atomic number information.

27. An apparatus as defined in claim 22, wherein the liquid merchandise includes one or more containers of liquid.

28. An apparatus as defined in claim 25, wherein said processing unit is programmed for:
comparing the observed response to penetrating radiation to the expected response to penetrating radiation;
using results of said comparing to determine if the liquid merchandise being screened is consistent with the identification information conveyed by the machine readable tag.

29. An apparatus as defined in claim 28, wherein said apparatus further comprises a memory module storing a knowledge hank including entries mapping different types of containers of liquid to one or more features, at least some features conveying expected responses of containers of liquid to penetrating radiation, said processing unit being programmed for using the identification information conveyed by the machine readable tag to locate one or more entries in the knowledge bank associated with the liquid merchandise.

30. An apparatus as defined in claim 29, wherein at least some features convey geometric information associated with containers of liquid.

31. An apparatus as defined in claim 22, wherein said processing unit is programmed for storing information on the machine readable tag, the information stored being related to the results obtained when determining if the liquid merchandise is consistent with the identification information.

32. An apparatus as defined in claim 22, wherein said processing unit is programmed for storing screening information on the machine readable tag, the screening information conveying either one of:
the observed response to penetrating radiation associated with the liquid merchandise; or
the expected response to penetrating radiation obtained using the identification information conveyed by the machine readable tag.

33. An apparatus as defined in claim 22, wherein the identification information includes a bar code component.

34. A method for facilitating the inspection of liquid merchandise comprising:
a. generating at a first location a machine readable tag conveying identification information related to the liquid merchandise;
b. associating the machine readable tag with the liquid merchandise;
c. at a security checkpoint located in a second location distinct from the first location, extracting the identification information from the machine readable tag;
d. processing the X-ray image of the liquid merchandise to derive an observed response to penetrating radiation associated with the liquid merchandise, the observed response including at least one feature conveying a characteristic of a liquid substance contained in the liquid merchandise; and
e. using the identification information in conjunction with the derived observed response to determine if the liquid merchandise is consistent with the identification information.

35. A method as defined in claim 34, wherein the observed response includes at least one of density information, linear attenuation information and effective atomic number information.

36. A method as defined in claim 34, wherein the first location is a duty free point of sale.

37. A method as defined in claim 36, wherein the duty free point of sale is located in a first airport and the security checkpoint is located in a second airport.

38. A method as defined in claim 36, wherein the duty free point of sale and the security checkpoint are both located in a same airport.

39. A method as defined in claim 35, said method comprising:
using the identification information conveyed by the machine readable tag to obtain an expected response to penetrating radiation associated with the liquid merchandise, the expected response being related to an expected content of the liquid merchandise;
comparing the observed response to penetrating radiation to the expected response to penetrating radiation;
using results of said comparing to determine if the liquid merchandise being screened is consistent with the identification information conveyed by the machine readable tag.

40. A method as defined in claim 35, wherein said method comprises:
placing the liquid merchandise in a receptacle;
placing the receptacle holding the liquid merchandise on a conveyor belt of an X-ray screening device;
subjecting the liquid merchandise to penetrating radiation to obtain the X-ray image of the duty free liquid merchandise while the duty free liquid merchandise remains in the receptacle.

41. A method as defined in claim 40, wherein said method further comprises sealing the receptacle so that no items other than the duty free liquid merchandise may be placed within the receptacle prior to subjecting the duty free liquid merchandise to penetrating radiation.

42. A method as defined in claim 35, wherein said method comprises storing information on the machine readable tag, the information stored being related to the results obtained when determining if the duty free liquid merchandise is consistent with the identification information.

43. A method as defined in claim 35, wherein said method comprises storing screening information on the machine readable tag, the screening information conveying either one of
the observed response to penetrating radiation associated with the duty free liquid merchandise; or
an expected response to penetrating radiation obtained using the identification information conveyed by the machine readable tag.

44. A method as defined in claim 35, wherein the machine readable tag includes a bar code component.

45. A method as defined in claim 44, wherein the bar code component includes a copper bar code.

46. An apparatus for inspecting liquid merchandise at a security checkpoint, the liquid merchandise being associated with a machine readable tag, the machine readable tag being generated in a location remote from the security checkpoint, said apparatus comprising;
a first input for receiving identification information related to the liquid merchandise from the machine readable tag;
a second input for receiving an X-ray image of the liquid merchandise derived by subjecting the liquid merchandise to penetrating radiation;
a processing unit in communication with the first input and the second input, said processing unit being programmed for:
a. processing the X-ray image of the liquid merchandise to derive an observed response to penetrating radiation associated with the liquid merchandise, the observed response including at least one feature conveying a characteristic of a liquid substance contained in the liquid merchandise; and
b. processing the identification information in conjunction with the derived observed response to determine if the liquid merchandise is consistent with the identification information;
an output in communication with the processing unit for releasing information conveying results obtained by the processing unit when determining if the liquid merchandise is consistent with the identification information.

47. An apparatus as defined in claim 46, wherein the observed response includes at least one of density information, linear attenuation information and effective atomic number information.

48. An apparatus as defined in claim 46, said processing unit being programmed for:
using the identification information conveyed by the machine readable tag to obtain an expected response to penetrating radiation associated with the liquid merchandise, the expected response being related to an expected content of the liquid merchandise;
comparing the observed response to penetrating radiation to the expected response to penetrating radiation;
using results of said comparing to determine if the liquid merchandise being screened is consistent with the identification information conveyed by the machine readable tag.

49. An apparatus as defined in claim 46, wherein said processing unit is programmed for storing information on the machine readable tag, the information stored being related to the results obtained when determining if the duty free liquid merchandise is consistent with the identification information.

50. An apparatus as defined in claim 46, wherein said method comprises storing screening information on the machine readable tag, the screening information conveying either one of:
the observed response to penetrating radiation associated with the duty free liquid merchandise; or
an expected response to penetrating radiation obtained using the identification information conveyed by the machine readable tag.

51. An apparatus as defined in claim 46, wherein the machine readable tag includes a bar code component.

52. An apparatus as defined in claim 51, wherein the bar code component includes a copper bar code.

53. A system for inspecting liquid merchandise comprising:
a. a tag generator module for generating a machine readable tag conveying identification information associated with liquid merchandise purchased at a point of sale;
b. a tag reader module for reading the machine readable tag associated with the liquid merchandise;
c. an x-ray screening device for subjecting the liquid merchandise to penetrating radiation to generate an X-ray image of the liquid merchandise;
d. an apparatus as defined in claim 22 for inspecting liquid merchandise at a security checkpoint to determine if the liquid merchandise is consistent with the identification information;
e. a display device in communication with said apparatus for displaying information related to the results obtained when determining if the liquid merchandise is consistent with the identification information.

54. A system as defined in claim 53, wherein the tag generator module comprises a bar code printing module for printing a bar code on a substrate, the bar code conveying identification information associated with the liquid merchandise.

55. A system as defined in claim 53, wherein the tag generator module comprises a bar code generation device for generating a copper bar code, the copper bar code conveying identification information associated with the liquid merchandise.

56. A system as defined in claim 53, wherein the computer readable tag includes an RFID component and wherein the tag generator module comprises an RFID writer for storing identification information associated with the liquid merchandise on the RFID component.

57. A system for inspecting liquid merchandise comprising:
a. a tag generator module for generating a machine readable tag conveying identification information associated with liquid merchandise purchased at a point of sale;
b. a tag reader module for reading the machine readable tag associated with the liquid merchandise;
c. an x-ray screening device for subjecting the liquid merchandise to penetrating radiation to generate an X-ray image of the liquid merchandise;
d. an apparatus as defined in claim 46 for inspecting liquid merchandise at a security checkpoint to determine if the liquid merchandise is consistent with the identification information;
e. a display device in communication with said apparatus for displaying information related to the results obtained when determining if the liquid merchandise is consistent with the identification information.
